(19) United States
(12) Patent Application Publication
(10) Pub. No.: US 2025/0004719 A1
(43) Pub. Date: Jan. 2, 2025

(54) SYSTEMS AND METHODS FOR PERFORMING DOUBLE PRECISION HIGH-SPEED ARITHMETIC OPERATION

(71) Applicant: SAMSUNG ELECTRONICS CO., LTD., SUWON-SI (KR)

(72) Inventors: Ganesh Prabhakar Katyarmal, Bangalore (IN); Amit Sharma, Bangalore (IN); Puneet Jangid, Bangalore (IN); Subhankar Ghosh, Bangalore (IN)

(21) Appl. No.: 18/506,607

(22) Filed: Nov. 10, 2023

(30) Foreign Application Priority Data
Jun. 29, 2023 (IN) 202341043724

(51) Int. Cl. G06F 7/544; G06F 7/499; G06F 7/57

(52) U.S. Cl. CPC G06F 7/5443; G06F 7/49942; G06F 7/57

(57) ABSTRACT

A method for performing a double precision high-speed arithmetic operation includes receiving first input data and second input data, generating first output data by performing a first logical operation on each of the first input data and the second input data, arranging a plurality of dot products in a row-wise manner, generating a second output data by performing a first arithmetic operation on the dot products, performing a transpose operation on a plurality of bit elements of the second output data by arranging least significant bits of the plurality of bit elements and the most significant bits in successive rows, and generating final output data by performing a second arithmetic operation on the transposed bit elements.

### CROSS-REFERENCE TO RELATED APPLICATION

This application claims priority under 35 U.S.C. § 119 from Indian Patent Application No. 202341043724, filed on Jun. 29, 2023 in the Indian patent office, the contents of which are herein incorporated by reference in their entirety.

### TECHNICAL FIELD

Embodiments of the present invention are directed to the field of integrated circuits for video processing, and more specifically relates to systems and methods for performing a double-precision high-speed arithmetic operation for an integrated circuit.

### DISCUSSION OF THE RELATED ART

As more media content, such as ultra-high definition (8K) videos, is being digitally generated, the technology for rendering these videos needs to be improved.

During video processing of ultra-high definition (8K) videos that have a high frame rate (144 Hz), the multiplication operation is the most time consuming and crucial operation for a high-performance Application Specific Integrated Circuit (ASIC) used for video processing. In particular, meeting the timing requirements for 64 bit×32 bit multiplication operation at 1400 MHz is challenging. Further, the conventional components involved in performing the multiplication operation fail to meet the timing requirements. In addition, the conventional components involved in performing complex multiplication operations result in inconclusive errors when combined with other operations performed during video processing.

### SUMMARY

According to an embodiment of the present disclosure, a method for performing a double-precision high-speed arithmetic operation for an integrated circuit includes receiving, from one or more register circuits, first input data and second input data. The first input data includes a first plurality of bits, and the second input data includes a second plurality of bits. The method also includes generating first output data by performing a first logical operation on each of the received first input data and second input data, where the first output data includes a plurality of dot products of the first plurality of bits and the second plurality of bits. The method further includes arranging the plurality of dot products in a row-wise manner. Furthermore, the method includes generating second output data by performing a first arithmetic operation on the plurality of row-wise arranged dot products. The second output data includes a plurality of bit elements. Moreover, the method includes performing a transpose operation on the plurality of bit elements of the second output data by arranging least significant bits (LSBs) of the plurality of bit elements and most significant bits (MSBs) of the plurality of bit elements in successive rows in a predefined manner. The method also includes generating final output data by performing a second arithmetic operation on the transposed plurality of bit elements.

According to another embodiment of the present disclosure, a system for performing a double precision high-speed arithmetic operation for an integrated circuit includes one or more register circuits that generate first input data and second input data. The first input data includes a first plurality of bits, and the second input data includes a second plurality of bits. The system also includes a first logical circuit that generates first output data by performing a first logical operation on each of the received first input data and second input data. The first output data includes a plurality of dot products of the first plurality of bits and the second plurality of bits. The first logical circuit also arranges the plurality of dot products in a row-wise manner. The system further includes a first computation circuit that generates second output data by performing a first arithmetic operation on the plurality of row-wise arranged dot products. The second output data includes a plurality of bit elements. The system also includes a transpose circuit that performs a transpose operation on the plurality of bit elements of the second output data by arranging least significant bits (LSBs) of the plurality of bit elements and most significant bits (MSBs) of the plurality of bit elements in successive rows in a predefined manner. Moreover, the system includes a second computation circuit that generates final output data by performing a second arithmetic operation on the transposed plurality of bit elements.

According to another embodiment of the present disclosure, there is provided a non-transitory program storage device readable by a computer, tangibly embodying a program of instructions executed by the computer to perform a method for performing a double precision high-speed arithmetic operation in an integrated circuit.

### BRIEF DESCRIPTION OF THE DRAWINGS

FIG. 1 is a schematic block diagram of an environment for video enhancement and display processing, according to an embodiment of the present disclosure.

FIG. 2 is an exemplary block diagram of a system that performs a double precision high-speed arithmetic operation in an integrated circuit, according to an embodiment of the present disclosure.

FIG. 3 illustrates an exemplary process flow of a multiplication process for video enhancement, according to an embodiment of the present disclosure.

FIG. 4 illustrates an exemplary process flow of a multiplication process for video enhancement, according to another embodiment of the present disclosure.

FIG. 5 is a flow chart of a method for performing a double precision high-speed arithmetic operation for an integrated circuit, according to an embodiment of the present disclosure.

### DETAILED DESCRIPTION

Embodiments of the present disclosure provide an enhanced video processing method that performs complex multiplication operations in a desired time period. A video processing method includes performing a double-precision high-speed arithmetic operation using an integrated circuit. For example, embodiments of the present disclosure provide an enhanced video processing method that performs multiplication operations for an integrated circuit that supports the conversion of high-resolution videos.

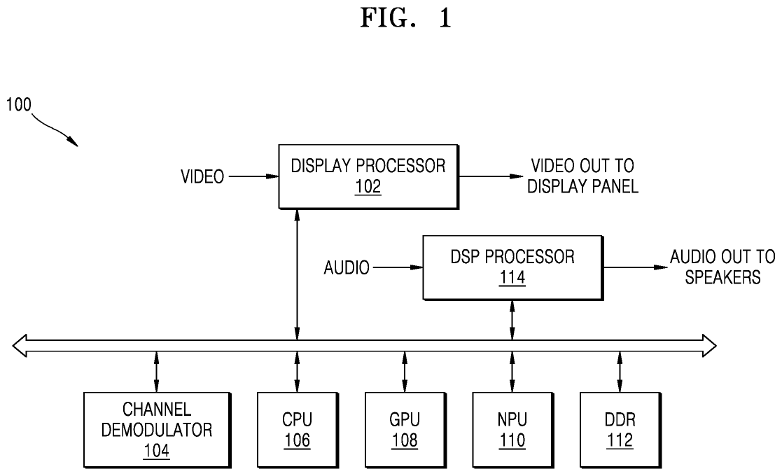

FIG. 1 is a schematic block diagram of an environment 100 for video enhancement and display processing, according to an embodiment of the present disclosure.

The system environment 100 includes a display processor 102, a channel demodulator 104, a Central Processing Unit (CPU) 106, a Graphical Processing Unit (GPU) 108, a Neural Processing Unit (NPU) 110, a Double Data Rate (DDR) memory 112, and a Digital Signal Processors (DSP) 114.

According to FIG. 1, the display processor 102 processes the received video signal and displays the processed video stream to a display device. Note that simplicity of illustration, the display device and/or display panel are not shown in FIG. 1.

The display processor 102 can reduce noise and/or artifacts in the received video signals. In an embodiment, the display processor 102 implements various techniques such as, but not limited to, spatial filtering, temporal filtering, and wavelet-based denoising, to reduce unwanted noise and/or artifacts in the received video signals/image frames. For example, the display processor 102 can effectively restore compressed video signals or video signals received from a noisy channel.

The display processor 102 can also adjust and/or modify various characteristics of the video signal. Such characteristics include, but are not limited to, resolution, aspect ratio, etc. In an embodiment, the display processor 102 implements various techniques such as, but not limited to, interpolation, decimation, filtering, etc., to adjust and/or modify the characteristics of the video signal.

The display processor 102 can further process the received video signal to enhance the sharpness and clarity of the video signal and/or image frames of the video signal. In an embodiment, the display processor 102 utilizes various image processing techniques such as, but not limited to, contrast enhancement, edge enhancement, and noise reduction, to reduce the noise in the video signal and add more clarity. In addition, the display processor 102 can implement various techniques such as, but not limited to, noise reduction, motion smoothing, color correction, contrast enhancement, etc., to improve the quality of the received video signal. For example, the display processor 102 can enhance the resolution of information in the received video signal to highlight details and increase the sharpness of the information.

In some embodiments, the display processor 102 can also adjust High Dynamic Range (HDR) values of the video signals and/or the image frames of the video signals in view of the display device.

The display processor 102 can also adjust the number of frames displayed per second. For example, the display processor 102 can synchronize a frame rate of the information being displayed over the display device with a refresh rate of the display device. Thus, the display processor 102 can eliminate various display issues such as, but not limited to, stuttering, jerky motion, tearing, etc.

Further, the display processor 102 can extend the resolution and/or refresh rate of the video signal. In an embodiment, the display processor 102 converts a lower resolution and/or refresh rate video signal into a higher resolution and/or refresh rate. Therefore, the display processor 102 improves the visual quality of the information in the video signal and eliminates resolution loss or distortion.

In an exemplary embodiment, to adjust and/or modify various characteristics/parameters of the video signal, the display processor 102 performs various arithmetic and/or logical operations. For example, the display processor 102 performs multiplication operations. The multiplication operation adjusts the overall brightness or contrast of the video signal and/or the image frames of the video signal. Further, in some embodiments, the multiplication operation is used to adjust a HDR value to a Low Dynamic Range (LDR) value. For example, if the HDR values of the image frame are too bright for an LDR display device, the multiplication operation is used to reduce the brightness by a certain factor, such as 0.3. The multiplication by the factor of 0.3 reduces the brightness of the image frame while preserving the details of the image frame.

The multiplication operation is also used to adjust the contrast of the image frame. A high-contrast image has a high brightness differences between dark and light areas of the image frame and a low-contrast image has lower brightness differences. Therefore, by adjusting the multiplication factor, the display processor 102 can adjust the contrast of the image frame.

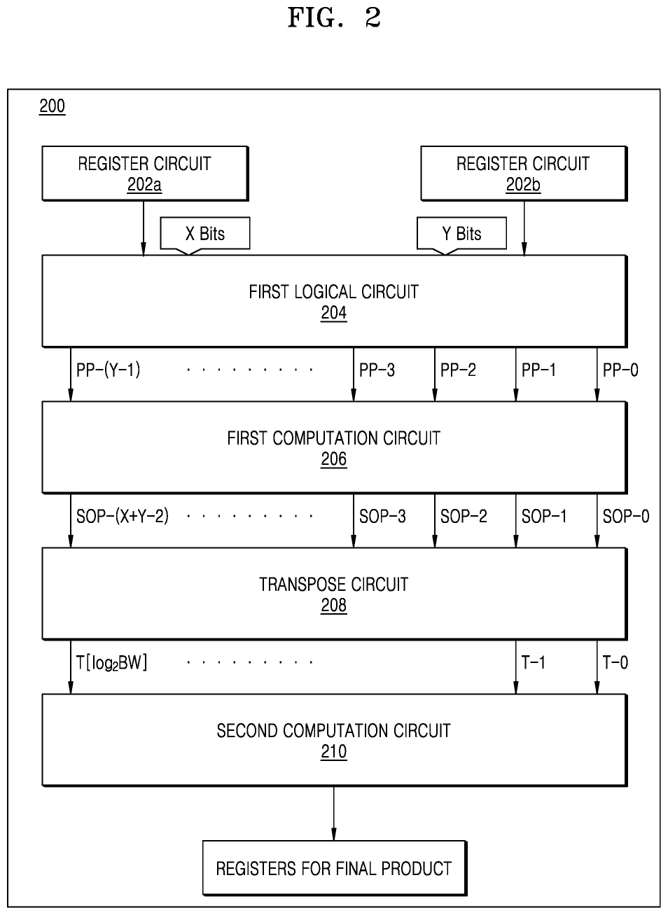

In an exemplary embodiment, the display processor 102 includes an integrated circuit that performs the double precision high-speed arithmetic operation to achieve the desired objective. The operation of the integrated circuit of the display processor 102 is described in detail with reference to FIGS. 2 through 5.

The display processor 102 displays the processed video signal by using the display device.

FIG. 1 also illustrates the channel demodulator 104, and various processing units such as the CPU 106, the GPU 108, the NPU 110, the DDR memory 112, and the DSP 114, which are generic in nature and perform conventionally known functions. Accordingly, a detailed description of these components has been omitted for the sake of brevity.

Embodiments are exemplary in nature and an integrated circuit that performs a double precision high-speed arithmetic operation can be implemented in any suitable technology area.

FIG. 2 is an exemplary block diagram of a system 200 that performs a double precision high-speed arithmetic operation in an integrated circuit, according to an embodiment of the present disclosure. In an embodiment, the system 200 corresponds to an IC and/or a device for double precision high-speed arithmetic operation.

The system 200 includes register circuit(s) 202a, and 202b, interchangeably referred to as “the register circuits 202”. The register circuits 202 generate first input data and second input data based on the received information and/or signal. In an embodiment, the information and/or signal received by the register circuits 202 corresponds to the video signals and/or the image frames in the video signals received by the display processor 102 shown in FIG. 1. Further, the first input data and the second input data correspond to pixel information of the video signals and the image frames in the video signals. Further, the first input data includes a first plurality of bits and the second input data includes a second plurality of bits.

In an exemplary embodiment, the arithmetic operation performed by the system 200 corresponds to a multiplication operation, the first input data corresponds to a multiplicand and the second input data corresponds to a multiplier.

The system 200 also includes a first logical circuit 204. The first logical circuit 204 receives the first input data and the second input data. The first logical circuit 204 generates first output data by performing a first logical operation on each of the received first input data and the second input data. In an exemplary embodiment, the first logical operation is a bitwise AND operation and the first logical circuit 204 performs the bitwise AND operation on each bit of the first input data and the second input data. In an embodiment, the first logical circuit 204 performs the bitwise AND operation on each bit of the first input data and the second input data to generate the first output data. Moreover, the first output data includes a plurality of dot products of the first plurality of bits that correspond to the first input data and the second plurality of bits that correspond to the second input data. In an embodiment, the first output data may be referred to as Partial Products (PP-0 to PP-(Y-1)). Further, the first logical circuit 204 arranges the plurality of dot products in a row-wise manner. In an embodiment, the first logical circuit 204 corresponds to a Gate circuit that implements the bitwise AND operation.

The system 200 also includes a first computation circuit 206. The first computation circuit 206 performs a first arithmetic operation on the plurality of row-wise arranged dot products to generate second output data. In an exemplary embodiment, the first arithmetic operation corresponds to an addition operation, and the first computation circuit 206 performs the addition operation on the plurality of row-wise arranged dot products and each of the plurality of bit elements is generated as an addition of the corresponding plurality of dot products. Further, the second output data includes a plurality of bit elements and each of the plurality of bit elements is generated as an addition of the corresponding plurality of dot products. In an embodiment, the first computation circuit 206 may also be referred to as a column adder circuit that implements an addition operation. Further, the second output data may be referred to as Sum of Partial Products (SOP-0 to SOP-(X+Y−2)).

The system 200 further includes a transpose circuit 208. The transpose circuit 208 performs a transpose operation on the plurality of bit elements of the second output data by arranging least significant bits (LSBs) of the plurality of bit elements and most significant bits (MSBs) of the plurality of bit elements in successive rows in a predefined manner. For example, the transpose circuit 208 rearranges the second output data and/or the sum of partial products. In an exemplary embodiment, the transpose circuit 208 generates a row of the sum of partial products by arranging the bit elements from the LSBs to the MSBs. Further, for each successive row, the transpose circuit 208 left shifts the plurality of bit elements of the second output data. After performing the transpose operation, the transpose circuit 208 generates the transposed plurality of bit elements. The transposed plurality of bit elements may be referred to as the transposed sum of partial products (T[0] to T[log₂BW]).

The system 200 further includes a second computation circuit 210. The second computation circuit 210 performs a second arithmetic operation on the transposed plurality of bit elements to generate the final output data. In an exemplary embodiment, the second arithmetic operation is an addition operation and the second computation circuit 210 simultaneously performs the addition operation on the corresponding transposed plurality of bit elements. In an embodiment, the final output data is a multiplication product of the first input data and the second input data. Further, the system 200 includes one or more register circuits that receive the final result and/or product.

In an exemplary embodiment, the first input data includes X number of bits and the second input data includes Y number of bits, where X does not necessarily equal Y. Further, the number of bits (Y) of the second input data may also be referred as the Bit width (BW). The first logical circuit 204 performs the bitwise AND operation on the first input data and the second input data to generate Y number of partial products. Further, each of the Y number of partial products includes X number of bit elements. For example, the number of partial products is equal to BW. Further, the first logical circuit 204 arranges the Y number of partial products in a row-wise manner and generates Y rows of partial products.

The first computation circuit 206 adds each column of the Y-number of partial products to generate (X+Y−1)-number of sum of partial products. The generated sum of partial products may be represented as PP_SUM. Further, the transpose circuit 208 transposes the generated sum of partial products in a row-wise manner such that each row includes the (X+Y−1)-number of bit elements. In an embodiment, the partial product sum has a maximum value that equates to BW. Therefore, the first computation circuit 206 requires log₂(BW)+1 bit to represent BW for the partial product sum. Accordingly, after the transpose operation by the transpose circuit 208, the T0 to T[log2(BW)] values are obtained. The second computation circuit 210 adds each of the T[log2(BW)]+1 number of transposed sum of partial products in parallel to generate a result of multiplication of the first input data and the second input data.

For example, if BW has 4 bits., the number of partial products will be 4. Further, the sum of partial products is less than or equal to 4. Further, since 3 bits are required to store the number 4, 3 rows are generated to represent PP_SUM. Further, 3 rows correspond to T0 to T[log2(4)] values from the transpose circuit 208.

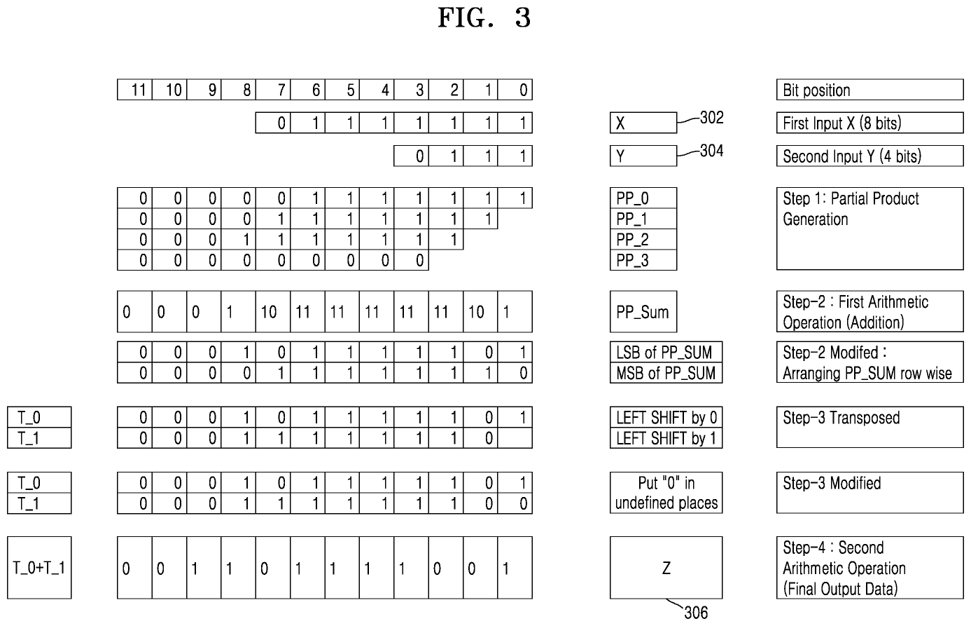

FIG. 3 illustrates an exemplary process flow for a multiplication process for video enhancement, according to an embodiment of the present disclosure.

For example, FIG. 3 illustrates the multiplication of first input data 302 and second input data 304, according to an embodiment of the present disclosure. The first input data 302 may be referred to as a multiplicand and the second input data 304 may be referred to as a multiplier. Further, the first input data 302 includes 8 bits positioned at index locations 0-7, and the second input data 304 includes 4 bits positioned at index locations 0-3. In an exemplary embodiment, the first input data 302 equates to value 127 in decimal format, and the second input data 304 equates to value 7 in decimal format.

At step 1, the first logical circuit 204 generates partial products of the first input data 302 and the second input data 304. Since the second input data 304 includes 4 bits, the first logical circuit 204 generates 4 partial products that are represented as PP_0, PP_1, PP_2, and PP_3, and that have been arranged in row-wise, as shown in FIG. 3. In an exemplary embodiment, the first logical circuit 204 generates the partial products PP_0 to PP_3 by performing a dot product operation on the first input data 302 and the second input data 304. In another embodiment, the first logical circuit 204 generates the partial products PP_0 to PP_3 by performing Bitwise Logical AND operations on the first input data 302 and the second input data 304.

At step 2, the first computation circuit 206 generates a sum of the partial products by performing a column-wise addition of the partial products. The generated sum of partial products may be represented as PP_SUM. The first computation circuit 206 also modifies the generated sum of partial products by separating the LSBs and the MSBs of the sum of partial products in separate rows.

At step 3, the transpose circuit 208 rearranges the row-wise data that includes the LSBs and MSBs of the sum of partial products in a predefined manner, which is referred as the transpose operation. For example, the transpose circuit 208 arranges the LSBs to MSBs in successive rows and left shifts each successive row by 1 more from the previous row. “0” is placed in undefined places. The modified sum of partial products that is generated by the transpose circuit 208 may also be represented as “T_0” and “T_1”.

At step 4, the second computation circuit 210 adds two terms of the modified sum of partial products (“T_0” and “T_1”) to generate the product 306 of the first input data 302 and the second input data 304. The product 306 may also be represented by the character “Z” that includes 12 bits and equates to a value of 889 in the decimal format.

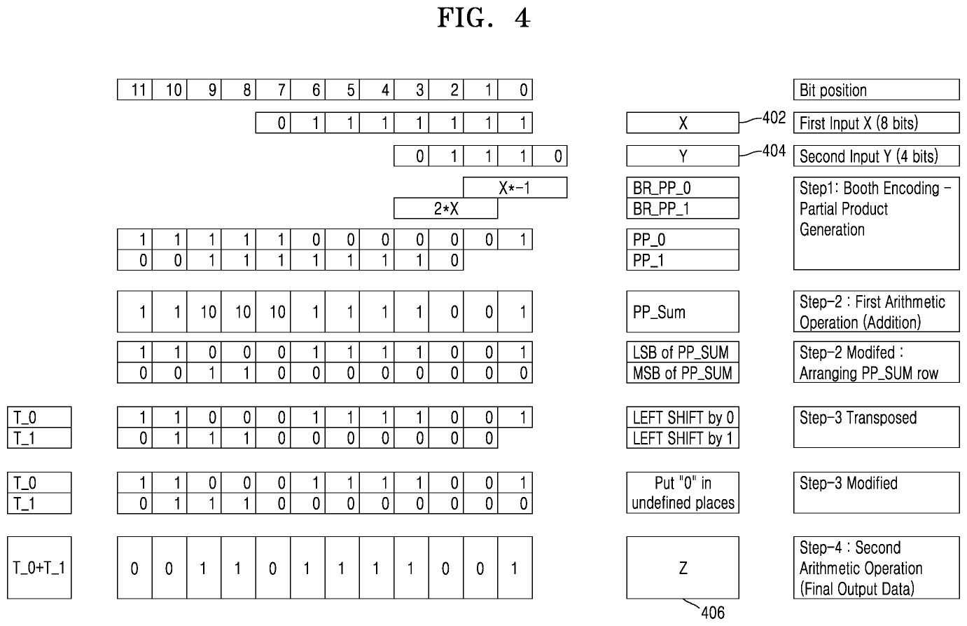

FIG. 4 illustrates an exemplary process flow for a multiplication process for video enhancement, according to another embodiment of the present disclosure.

For example, FIG. 4 illustrates the multiplication of first input data 402 and second input data 404, according to an embodiment of the present disclosure. The first input data 402 may be referred to as a multiplicand and the second input data 404 may be referred to as a multiplier. Further, the first input data 402 includes 8 bits positioned at index locations 0-7 and the second input data 404 includes 4 bits positioned at index locations 0-3. Initially, the system 200 performs booth encoding of the second input data to generate two bits that correspond to the second input data 404.

At step 1, the first logical circuit 204 generates partial products of the first input data 402 and the second input data 404. In an embodiment, the logical circuit 204 implements a booth encoding technique that generates the partial products. The partial products generated by the first logical circuit 204 are represented as PP_0 and PP_1 that have been arranged row-wise. In an embodiment, the partial products PP_0 and PP_1 are generated using BOOTH encoding techniques for the bits of the second input data (i.e., multiplier) as per the booth-encoding radix-4 rule (BR_PP_0 and BR_PP_1).

Further, the steps 2-4 are similar to steps 2-4, as described with reference to FIG. 3, therefore a description of these steps has been omitted for the sake of brevity. Further, the product 406 is obtained as a multiplication result from the first input data 402 and the second input data 404, according to an embodiment of the present disclosure.

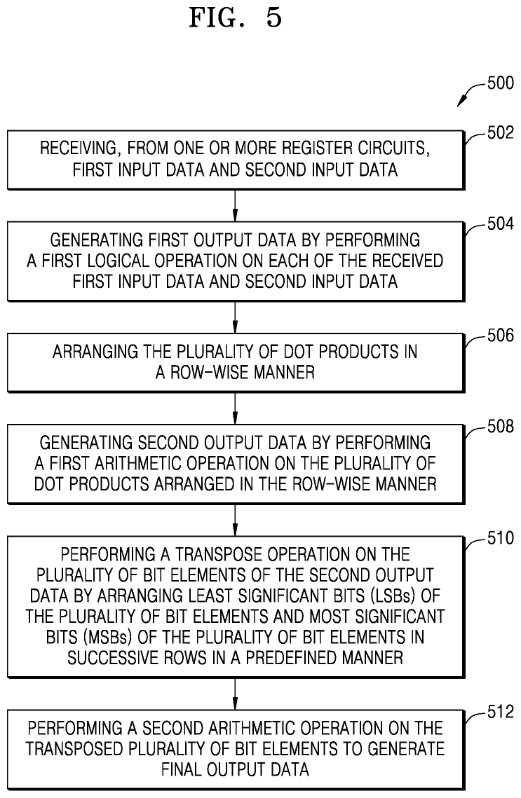

FIG. 5 is a flow chart of a method 500 for performing a double precision high-speed arithmetic operation in an integrated circuit, according to an embodiment of the present disclosure.

Referring to FIG. 5, in an embodiment, at step 502, the method 500 includes receiving first input data and second input data from the one or more register circuits 202a, 202b. The first input data includes a first plurality of bits, and the second input data includes a second plurality of bits.

At step 504, the method 500 includes generating first output data by performing a first logical operation on each of the received first input data and second input data. The first output data includes a plurality of dot products of the first plurality of bits and the second plurality of bits. The first logical operation is a bitwise AND operation, and the bitwise AND operation is performed on each bit of the first input data and the second input data.

At step 506, the method 500 includes arranging the plurality of dot products in a row-wise manner. At step 508, the method 500 includes generating second output data by performing a first arithmetic operation on the plurality of row-wise arranged dot products. The second output data includes a plurality of bit elements. In an embodiment, the first arithmetic operation is an addition operation performed on the plurality of row-wise arranged dot products. Further, each of the plurality of bit elements is generated by an addition of the corresponding plurality of dot products.

At step 510, the method 500 includes performing a transpose operation on the plurality of bit elements of the second output data by arranging least significant bits (LSBs) of the plurality of bit elements and most significant bits (MSBs) of the plurality of bit elements in successive rows in a predefined manner. Further, at step 512, the method 500 includes performing a second arithmetic operation on the transposed plurality of bit elements to generate final output data. In an exemplary embodiment, the second arithmetic operation is an addition operation that is simultaneously performed on the corresponding transposed plurality of bit elements. Further, the final output data is a multiplication product of the first input data and the second input data.

Embodiments as discussed above are non-limiting and exemplary. Accordingly, the method 500 may include additional steps or omit some of the above-mentioned steps to perform the desired objective of embodiments of the present disclosure. Further, the steps of the method 500 can be performed in any suitable order and/or by any suitable component of the system 300 to achieve the desired outcome.

Therefore, embodiments of the present disclosure provides various technical effects, including but not limited to, significantly reducing the number of steps required to perform the multiplication of the first input data and the second input data. By reducing the number of multiplication steps, embodiments of the present disclosure can support a high resolution (8 k) and a high frame rate (144 hz) video generation. Further, by reducing the number of steps, embodiments of the present disclosure reduce the latency of the system.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

1. A method for performing a double precision high-speed arithmetic operation in an integrated circuit, comprising:
receiving, from one or more register circuits, first input data and second input data, wherein the first input data includes a first plurality of bits, and the second input data includes a second plurality of bits;
generating first output data by performing a first logical operation on each of the received first input data and second input data, wherein the first output data includes a plurality of dot products of the first plurality of bits and the second plurality of bits;
arranging the plurality of dot products in a row-wise manner;
generating second output data by performing a first arithmetic operation on the plurality of row-wise arranged dot products, wherein the second output data includes a plurality of bit elements;
performing a transpose operation on the plurality of bit elements of the second output data by arranging least significant bits (LSBs) of the plurality of bit elements and most significant bits (MSBs) of the plurality of bit elements in successive rows in a predefined manner; and
generating final output data by performing a second arithmetic operation on the transposed plurality of bit elements.

2. The method as claimed in claim 1, wherein the first logical operation is a bitwise AND operation, and
wherein the bitwise AND operation is performed on each bit of the first input data and the second input data.

3. The method as claimed in claim 1, wherein the first arithmetic operation is an addition operation performed on the plurality of row-wise arranged dot products, and
each of the plurality of bit elements is generated as an addition of the corresponding plurality of dot products.

4. The method as claimed in claim 1, wherein the second arithmetic operation corresponds to an addition operation, and
wherein the addition operation is simultaneously performed on the corresponding transposed plurality of bit elements.

5. The method as claimed in claim 1, wherein the one or more register circuits generate first input data and second input data based on video signals and/or image frames in the video signals received by a display processor.

6. The method as claimed in claim 1, wherein generating first output data includes Booth encoding bits of the second input data.

7. A system for performing a double precision high-speed arithmetic operation for an integrated circuit, comprising:
one or more register circuits that generate first input data and second input data, wherein the first input data includes a first plurality of bits, and the second input data includes a second plurality of bits;
a first logical circuit that:
generates first output data by performing a first logical operation on each of the received first input data and second input data, wherein the first output data includes a plurality of dot products of the first plurality of bits and the second plurality of bits; and
arranges the plurality of dot products in a row-wise manner;
a first computation circuit that generates second output data by performing a first arithmetic operation on the plurality of row-wise arranged dot products, wherein the second output data includes a plurality of bit elements;
a transpose circuit that performs a transpose operation on the plurality of bit elements of the second output data by arranging least significant bits (LSBs) of the plurality of bit elements and most significant bits (MSBs) of the plurality of bit elements in successive rows in a predefined manner; and
a second computation circuit that generates final output data by performing a second arithmetic operation on the transposed plurality of bit elements.

8. The system as claimed in claim 7, wherein the first logical operation is a bitwise AND operation, and
wherein the first logical circuit performs the bitwise AND operation on each bit of the first input data and the second input data.

9. The system as claimed in claim 7, wherein the first arithmetic operation is an addition operation, and
wherein the first computation circuit performs the addition operation on the plurality of dot products arranged in the row-wise manner, and each of the plurality of bit elements is generated as an addition of the corresponding plurality of dot products.

10. The system as claimed in claim 7, wherein the second arithmetic operation is an addition operation, and
wherein the second computation circuit simultaneously performs the addition operation on the corresponding transposed plurality of bit elements.

11. The system as claimed in claim 7, wherein the final output data is a multiplication product of the first input data and the second input data, and the system further includes one or more register circuits that receive the final output data.

12. The system as claimed in claim 7, wherein the first input data includes X number of bits, the second input data includes Y number of bits, the first logical circuit generates Y number of partial products from the first input data and the second input data, each of the Y number of partial products includes X number of bit elements, and the first computation circuit generates (X+Y−1)-number of sum of partial products by adding each column of the Y-number of partial products.

13. The system as claimed in claim 7, wherein, for each successive row, the transpose circuit generates a modified sum of partial products by left shifting the plurality of bit elements of the second output data by 1 more from a previous row, and places a “0” in an undefined place.

14. The system as claimed in claim 13, the second computation circuit generate a product of the first input data and the second input data by adding two terms of the modified sum of partial products.

15. A non-transitory program storage device readable by a computer, tangibly embodying a program of instructions executed by the computer to perform a method for performing a double precision high-speed arithmetic operation in an integrated circuit, the method comprising:
receiving first input data and second input data, wherein the first input data includes a first plurality of bits, and the second input data includes a second plurality of bits;
generating first output data by performing a first logical operation on each of the received first input data and second input data, wherein the first output data includes a plurality of dot products of the first plurality of bits and the second plurality of bits;
arranging the plurality of dot products in a row-wise manner;
generating second output data by performing a first arithmetic operation on the plurality of row-wise arranged dot products, wherein the second output data includes a plurality of bit elements;
performing a transpose operation on the plurality of bit elements of the second output data by arranging least significant bits (LSBs) of the plurality of bit elements and most significant bits (MSBs) of the plurality of bit elements in successive rows in a predefined manner; and
generating final output data by performing a second arithmetic operation on the transposed plurality of bit elements.

16. The non-transitory computer readable program storage device as claimed in claim 15, wherein the first logical operation is a bitwise AND operation, and
wherein the bitwise AND operation is performed on each bit of the first input data and the second input data.

17. The non-transitory computer readable program storage device as claimed in claim 15, wherein the first arithmetic operation is an addition operation performed on the plurality of row-wise arranged dot products, and
each of the plurality of bit elements is generated as an addition of the corresponding plurality of dot products.

18. The non-transitory computer readable program storage device as claimed in claim 15, wherein the second arithmetic operation corresponds to an addition operation, and
wherein the addition operation is simultaneously performed on the corresponding transposed plurality of bit elements.

19. The non-transitory computer readable program storage device as claimed in claim 15, wherein the method further comprises generating the first input data and second input data from video signals received by a display processor.

20. The non-transitory computer readable program storage device as claimed in claim 15, wherein generating first output data includes Booth encoding bits of the second input data.
